(19) United States
(12) Patent Application Publication
(10) Pub. No.: US 2014/0091920 A1
(43) Pub. Date: Apr. 3, 2014

(54) U-TURN SIGNALING SYSTEM AND METHOD

(71) Applicant: Ervin Thompson, Sacramento, CA (US)

(72) Inventor: Ervin Thompson, Sacramento, CA (US)

(21) Appl. No.: 13/629,604

(22) Filed: Sep. 28, 2012

(51) Int. Cl. B60Q 1/34

(52) U.S. Cl. 340/475

(57) ABSTRACT

A U-turn signaling system and method. The U-turn signaling system signals an intent to orient a vehicle in a substantially opposite direction. The U-turn signal might have an inverted U shape. The signaling system also includes a control circuitry for controlling the U-turn output signal responsive to user actuation of a U-turn signal switch.

### BACKGROUND OF THE INVENTION

The present invention relates generally to signaling systems and methods and more specifically to signaling systems and methods for signaling a change in direction of travel of a vehicle.

A signaling system for a vehicle includes visible illumination and audio devices that are helpful in alerting other motorists about a vehicle's intent to change directions or velocity. Such directional changes can include left turns, right turns, reverse, stopping or velocity change, U-turns, etc.

As an example, FIG. 1 illustrates a typical four-way intersection 100, in which vehicle 102 intends to make a U-turn and notify other motorists of its impending directional change. In FIG. 1, vehicle 102 travelling north, reduces its velocity to negotiate the U-turn at intersection 100. The U-turn by vehicle 102 is traversed along path 104 south.

As is conventional, vehicle 102 has actuated its left turn signal to apprise motorists 102 110, 114 and 118 of its impending direction change. Upon observing the left turn signal of vehicle 102, all of the other motorists 110, 114 and 118 erroneously assume that vehicle 102 is turning west along path 105 (indicated by dashed lines).

Specifically, as vehicle 102 proceeds from A to B along path 104 to make the U-turn, motorist 118 wishing to make a right turn south along path 107 has observed vehicle 102's left turn signal, and believes that vehicle 102 will turn left, that is, west along path 105. Instead, vehicle 102 swings a wide U-turn south along path 104 causing both vehicle 102 and motorist 118 to collide at 120, causing inevitable property damage, injury and possible loss of life.

A similar situation is applicable to motorist 114. Specifically, as vehicle 102 proceeds along path 104 to make the U-turn, motorist 114 begins to change direction east along path 109, believing that vehicle will traverse a left turn west along path 105. Rather, vehicle 102 swings a wide U-turn along path 104 so that vehicle 102 and motorist 114 forcefully engage at 116, causing inevitable property damage, injury and possible loss of life.

Similarly, motorist 110 and vehicle 102 might collide at point 112 because motorist 110 observed the left turn signal and believed that vehicle 102 was turning left to go west when, in fact, vehicle 102 was negotiating a U-turn south along path 104. The result is a possible collision between vehicle 102 and motorist 110 at point 112, the collision resulting in property or human casualties.

The aforementioned situation is also applicable to motorist 106 travelling behind vehicle 102. A collision between motorist 106 and vehicle 102 might occur at point 108 because motorist 106 having observed the left turn signal, assumes that vehicle 102 is turning left and is either unprepared for the reduced velocity required for a U-turn or the wide swing along path 104. Again, this resulting collision might cause property damage or human casualty.

There is a need to address one or more of the foregoing disadvantages of conventional systems and methods, and the present invention meets this need.

### BRIEF SUMMARY OF THE INVENTION

Various aspects of a turn signaling system and method can be found in exemplary embodiments of the present invention.

In a first embodiment, the turn signaling system signals an intent by a vehicle to reorient the vehicle in a substantially opposite direction. Here, the turn signaling system might include a left U-turn signal indicator for both the front and rear ends of the vehicle. Alternatively, depending upon the traffic system in use, the turn signaling system might also include a right U-turn signal indicator for both the front and rear ends of the vehicle. In fact, the turn signaling systems can comprise both the left and the right U-turn signal indicators for the vehicle.

Among other components, the turn signaling system also includes a turn signal actuator positioned on a dashboard and turn signal control circuitry. Upon manipulation of the turn signal actuator by the motorist to signal an impending U-turn, the control circuitry triggers the U-turn signal indicator to emit visible light that can be observed by motorists in close proximity.

In this manner, the turn signaling system of the present invention provides a visible illumination that is helpful in alerting other motorists about the vehicle's intent to change direction and/or velocity. Unlike conventional systems that utilize left or right turn signals for U-turns, the present invention employs appropriate U-turn signal indicators to indicate an impending U-turn to properly alert other motorists about the intended U-turn thus preventing forcible collision, property damage and possible human casualty associated with prior art systems.

A further understanding of the nature and advantages of the present invention herein may be realized by reference to the remaining portions of the specifications and the attached drawings. Further features and advantages of the present invention as well as the structure and operation of various embodiments of the present invention are described in detail below with respect to the accompanying drawings. In the drawings, the same reference numbers indicate identical or functionally similar elements.

### BRIEF DESCRIPTION OF THE DRAWINGS

The present invention is illustrated by way of example, and not by way of limitation in the figures of the accompanying drawings and in which like reference numerals refer to similar elements and in which:

FIG. 1 illustrates a four-way intersection in which a vehicle contemplating a directional change is signaling other motorists;

FIG. 2A illustrates a front view of a vehicle incorporating a turn signaling system in accordance with an exemplary embodiment of the present invention;

FIG. 2B further illustrates the signaling system of FIG. 2A in accordance with an exemplary embodiment of the present invention;

FIG. 2C is a cross sectional view of the signaling system of FIG. 2B according to an exemplary embodiment of the invention;

FIG. 2D illustrates a rear view of a vehicle incorporating a turn signaling system in accordance with an exemplary embodiment of the present invention;

FIG. 3 illustrates various components of a turn signaling system in accordance with an exemplary embodiment of the present invention;

FIG. 4 illustrates a vehicle incorporating a turn signaling system according to an exemplary embodiment of the present invention;

FIG. 5 illustrates a signaling system configured into a circular shape, in accordance with an exemplary embodiment of the present invention;

FIG. 6 illustrates a dashboard of a vehicle with a turn signal actuator positioned in it according to an exemplary embodiment of the present invention.

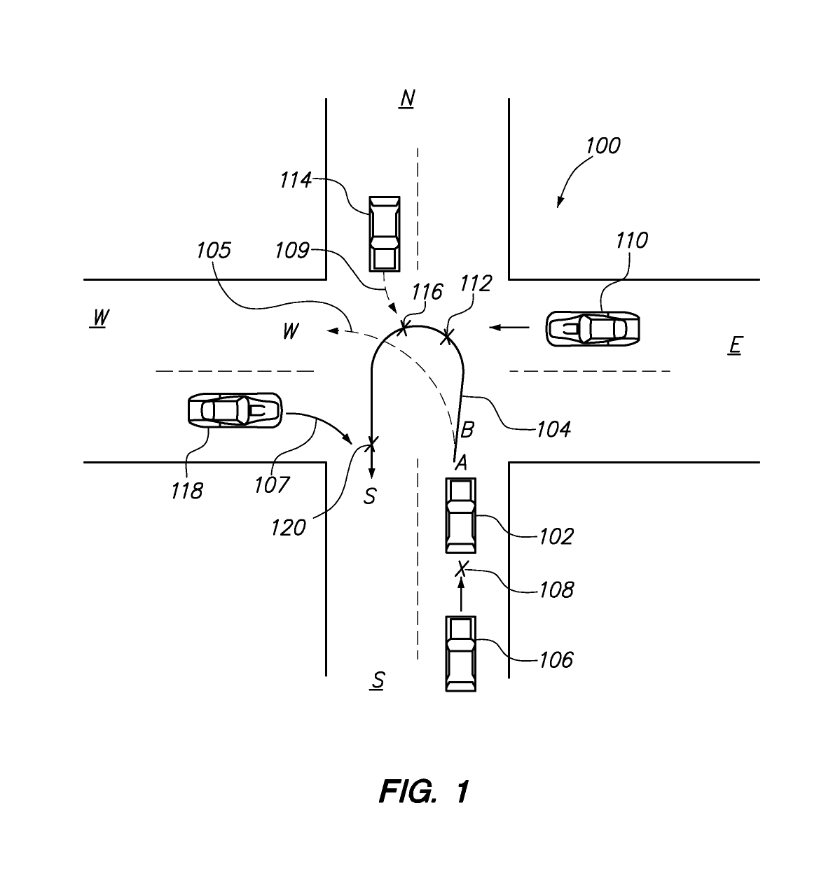

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail so as to not unnecessarily obscure aspects of the present invention.

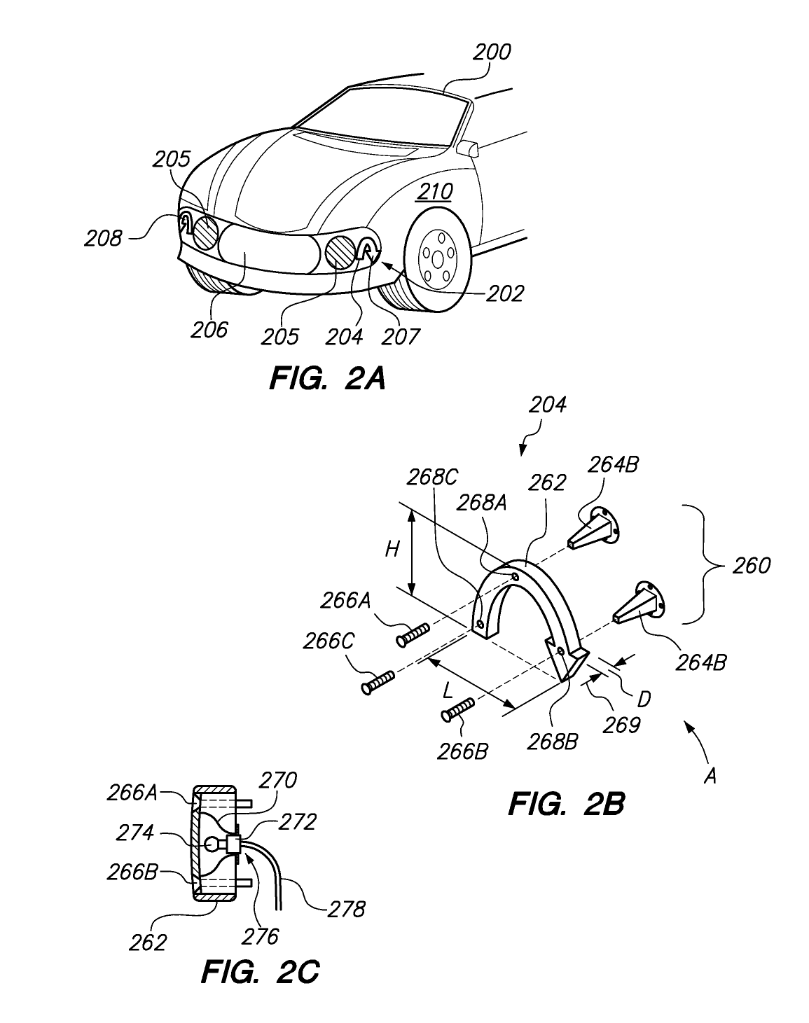

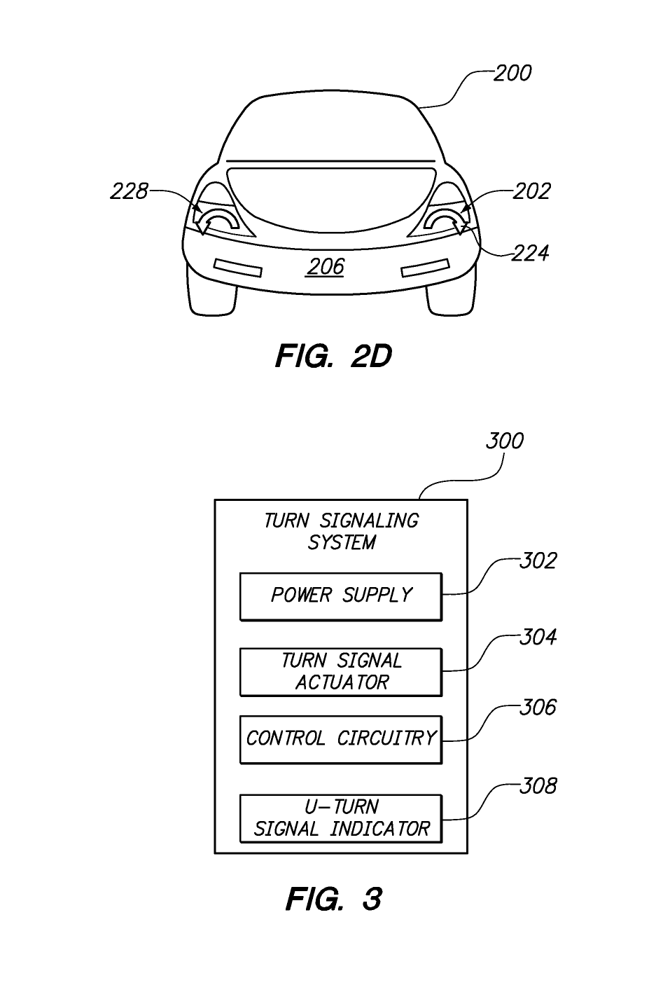

FIG. 2A illustrates vehicle 200 incorporating turn signaling system 202 in accordance with an exemplary embodiment of the present invention.

In FIG. 2A, vehicle 200 is an automobile for transporting people or cargo. Vehicle 200 is four-wheeled, a front portion of which is shown. Although not shown, vehicle 200 may have three or more wheels such as a semi-trailer for example. Vehicle 102 may also be a two-wheeled vehicle such as a motorcycle.

In FIG. 2A, among other components, turn signaling system 202 includes left U-turn signal 204 and right U-turn signal 208; each of said left U-turn signal 204 and right U-turn signal 208 being positioned on front end 206 of vehicle 102. Front end 206 is a bumper member designed to support vehicle 102 during a frontal crash. Although not shown, the respective U-turn signals can be positioned above or below the bumper member of such body member 210 of vehicle 102.

In one embodiment, turn signaling system 202 is configured to signal an intent to orient vehicle 102 in a substantially opposite direction. Specifically, turn signal system 202 can alert an oncoming motorist as well as other motorists and passersby that vehicle 102 intends to negotiate a U-turn. In this manner, motorists and passersby are informed of vehicle's 102 impending U-turn maneuver so that such motorists can be prepared and make necessary driving adjustments to accommodate the intended U-turn maneuver.

As shown, left U-turn signal 204 and right U-turn signal 208 of turn signaling system 202 are positioned prominently on the front end 206 of vehicle 102. The shape of left U-turn signal 204 and right signal 208 may be that of an inverted U as illustrated. Advantageously, in one embodiment, this inverted U shape is important as it is indicative of the path vehicle 102 normally follows while performing a U-turn; thus, it is immediately clear to other motorists that a directional change in the substantially opposite direction is intended.

As shown, the inverted U shape may also have arrowhead 207 to indicate direction. One skilled in the art will realize that the inverted U shape need not comprise the indicated arrowhead 207.

Alternatively, the shape of left U-turn signal 204 and right U-turn signal 208 may be round (not shown), for example in which case, a U-shaped arrow may be incorporated on the round left U-turn signal 204 and right U-turn signal 208. In other embodiments, turn signaling system 202 can utilize various symbols, shapes, colors, and flashing patterns.

Thus, turn signaling system 202 can include a flashing illumination that emits light from a cylindrical shape. However, other shapes can be utilized for turn signaling system 202, including, without limitation, a cube, a sphere, a rectangle, etc. In one embodiment, the flashing illumination that emits from turn signaling system 202 includes 60 to 120 flashes per minute. In another embodiment, the flashes follow a synchronized pattern that may flash less than 60 times, or greater than 120 times per minute. In yet another embodiment, the rate of the flashes correlates to the speed that vehicle 102 is moving while performing the U-turn.

Turn signaling system 202 may also position separately from a multiplicity of turn signals 205. In other embodiments, turn signaling system 202 integrates with a multiplicity of turn signals 205, including, without limitation, a left turn signal, a right turn signal, a brake light, etc.

FIG. 2B illustrates a perspective view of left U-turn signal 204 of FIG. 2B.

In FIG. 2B, specifically, housing assembly 260 of left U-turn signal 240 is depicted. Here, housing assembly 260 includes main housing 262 that is preferably inverted U-shaped with optional arrow head 269 shown in broken lines. Main housing 262 has a generally rectangular or squared-shaped cross section when viewed from direction of arrow A. This rectangular or squared-shaped cross section depends upon the dimensions of left U-turn signal 204. Main housing 262 comprises a translucent plastic material that might be preferably formed by injection molding. In one embodiment, the plastic color is orange. In another embodiment, the plastic color is red. Main housing 262 houses components of left U-turn signal 204 as further discussed with reference to FIG. 2C.

Main housing 262 is fixedly attached to brackets 264A, 264B and 264C (not shown) via three hole mounting. Brackets 264A, 264B and 264C are attached to the frame support member (not shown) of vehicle 200. Screw 266A attaches main housing 262 to bracket 264A via hole 268A. Screw 266B attaches main housing 262 to bracket 264B via hole 268B. Screw 266C attaches main housing 262 to bracket 264C (not shown) via hole 268C.

In the present embodiment, the height H of main housing 262 is 6¾ inches, the length L is 7 inches while the depth D is 2¾ inches. One skilled in the art will realize that the stated dimensions are exemplary and that actual dimensions will depend on the vehicle itself and the make and model. Other components of left U-turn signal 204 have been omitted as not to unnecessarily obscure details of the invention.

FIG. 2C illustrates a cross sectional view of left U-turn signal 204 when viewed from direction A of FIG. 2B.

In FIG. 2C, left U-turn signal 204 includes lens 270 that is preferably colorless. Left U-turn signal 204 also includes socket 272 into which bulb 274 is inserted. Socket 272 is centered via opening 276 and held in place via screws (not shown). As shown here, screw 266A has been screwed into main housing 262 while screw 266B has also been screwed into main housing 262 to hold main housing 262 securely in place. The brackets 264A and 264B are not shown. Electrical leads 278 extend from the back of socket 272 through opening 276 of main housing 262.

FIG. 2D illustrates vehicle 200 incorporating turn signaling system 202 in accordance with an exemplary embodiment of the present invention.

In FIG. 2D, turn signaling system 202 indicates a driver's intent to perform a U-turn. Signaling system 200 includes rear right U-turn signal 224 and rear left U-turn signal 228 that are inverted U-shaped. Alternatively, the rear U-turn signals might be rounded to incorporate an inverted U-shaped arrow on the face of the turn signals. In this manner, motorists positioned behind vehicle 102 can be aware of any impending U-turns by vehicle 102.

Those skilled in the art will recognize that performing a U-turn requires vehicle 102 to decelerate at a greater rate than performing a left turn. Consequently, the motorist positioned directly behind vehicle 200 is most at risk to forcibly engage vehicle 102 from behind during vehicle's 200 increased deceleration. Signaling system 202 provides the alert that not only is vehicle 200 intending on performing the U-turn, but that vehicle 200 is decelerating more than with a normal left turn.

FIG. 3 illustrates various components of turn signaling system 300 in accordance with an exemplary embodiment of the present invention.

In FIG. 3, among other components, turn signaling system 300 comprises power supply 302 that generates current and voltage for powering turn signaling system 202 (FIG. 2A). Turn signaling system 300 utilizes the power supply 302 which is preferably 12 volts.

Turn signaling system 300 also includes turn signal actuator 304 that can be manipulated by a user or motorist from inside vehicle 200. Those skilled in the art will recognize that a lever that extends from an interior region of vehicle 200 can be manipulated to various positions to actuate both turn signaling system 300, and a multiplicity of turn signals (not shown). A button that positions on a dashboard of vehicle 200 can also serve to trigger turn signaling system 300 by depressing the button.

In FIG. 3, turn signaling system 300 also includes control circuitry 306. Responsive to user input, control circuitry 306 actuates one or more U-turn signal indicators 308 so that they are visible to other motorists. Upon detecting a U-turn input signal generated when a user actuates turn signal actuator 304, control circuitry 306 generates a U-turn output signal that actuates U-turn signal indicator 308.

As shown, turn signaling system 300 further includes one or more U-turn signal indicators 308 that provide visible lighting that alerts motorists when vehicle 200 wishes to negotiate a U-turn. In one embodiment, turn signaling system 300 comprises at least a light bulb and lens assembly arrangement within a translucent housing. However, U-turn indicator 308 might include any signaling mechanism that alerts motorists as to an intent to change direction in a substantially opposite direction.

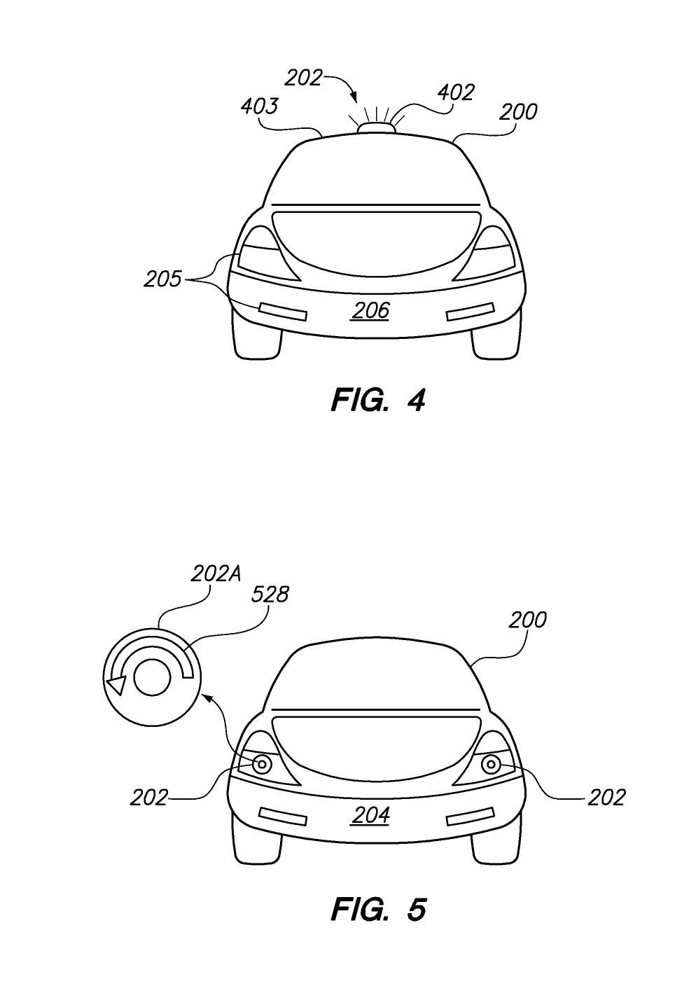

FIG. 4 illustrates vehicle 200 incorporating turn signaling system 202 according to an exemplary embodiment of the present invention.

In FIG. 4, turn signaling system 202 includes a single U-turn signal indicator 402 as shown. U-turn signal indicator 402 is located rearwardly on roof 403 of vehicle 200. In one embodiment, U-turn signal indicator 402 includes a rotating light mechanism (not shown). Upon actuating a U-turn signal switch, the rotating light mechanism of U-turn signal indicator 402 begins to rotate and alert other motorists that the driver wishes to negotiate a U-turn.

In the present embodiment, the rotating mechanism can emit a flashing light of a bright color such as red or yellow that creates additional awareness for surrounding motorists. Specifically, motorists behind, in front and to the left and right sides of vehicle 200 can easily see the flashing light emitted by the rotating mechanism so that such motorists can adjust their driving accordingly. Turn signaling system 202 can also flash or blink in a manner that attracts visual attention.

FIG. 5 illustrates turn signaling system 202 configured into a circular shape, in accordance with an exemplary embodiment of the present invention.

In FIG. 5, turn signaling system 202 can include flashing illumination that emits light from the circular shape. However, other shapes and graphical embodiments can be utilized. Turn signaling system 202 includes an internal U-Turn signal indicator arrow 528 as illustrated by exploded view 202A of turn signaling system 202

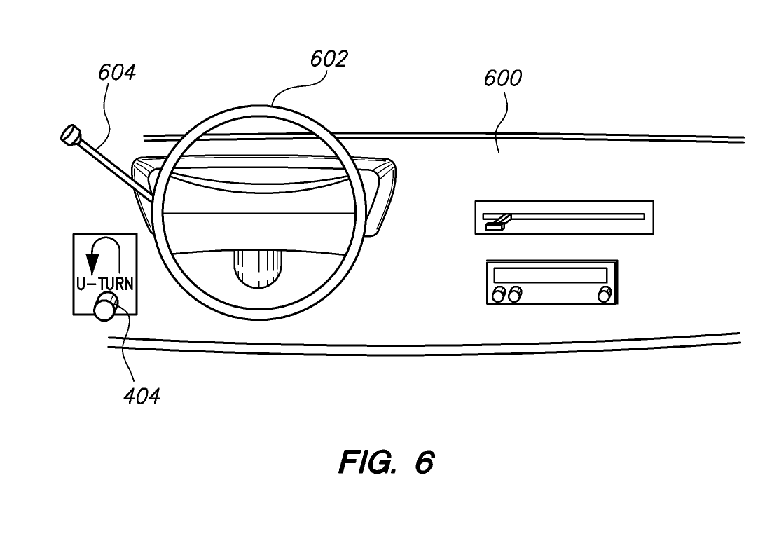

FIG. 6 illustrates dashboard 600 of vehicle 200 with turn signal actuator 604 positioned inside in accordance with an exemplary embodiment of the present invention.

In FIG. 6, dashboard 600 provides an internal, accessible area from which to manipulate turn signal actuator 604. Turn signal actuator 604 can include a lever that extends from a steering column 602 or a button (not shown) positioned on dashboard 600. However, in other embodiments, other forms of turn signal actuators 604 can be used, including, without limitation, a touch screen, a knob, etc.

According to a further embodiment, the present invention includes a method that can be implemented by turn signaling system 300 of FIG. 3, for example, when vehicle 200 wishes to perform a U-turn. This method includes receiving a user-input signal initiated by the driver of vehicle 200 to show an intent to change a direction of travel of vehicle 200 from one direction to a substantially opposite direction. Those skilled in the art will recognize that vehicle 200 often requires changing directions while driving. Performing the U-turn allows vehicle 200 to orient in a substantially opposite direction. Signaling system 300 then performs the task of displaying an intent to change the direction of travel of vehicle 200 from the one direction to the substantially opposite direction. This is performed by manipulating turn signal actuator 304 (FIG. 3) or 604 (FIG. 6), which generates the U-turn input signal through control circuitry 306. The method then includes generating the U-turn output signal based at least in part on the U-turn input signal. The U-turn signal indicator of the present invention then uses the U-turn output signal to emit light that is observable by motorists in close proximity.

While the above is a complete description of exemplary specific embodiments of the invention, additional embodiments are also possible. Thus, the above description should not be taken as limiting the scope of the invention, which is defined by the appended claims along with their full scope of equivalents.

I claim:

1. A turn signaling system for use with vehicles to indicate directional changes, the turn signaling system comprising:
a vehicle, the vehicle comprising a front end and a rear end, the vehicle further comprising a first U-turn signal indicator on said front end and a second U-turn indicator on said rear end of the vehicle, the first U-turn signal indicator and the second U-turn signal indicator being operable to signal an intent to orient the vehicle in a direction substantially opposite to the direction of travel of the vehicle;
the vehicle further comprising a dashboard, the dashboard comprising a U-turn signal actuator, the U-turn signal actuator being operable to actuate the turn signaling system, the dashboard further comprising a steering portion, the steering portion being operable to orient the vehicle in said substantially opposite direction as indicated upon actuation of said U-turn signal actuator; and
a control circuitry, the control circuitry comprising a U-turn input signal, the U-turn input signal being triggered by manipulation of the U-turn signal actuator, the control circuitry further comprising a U-turn output signal, the U-turn output signal based at least in part on the U-turn input signal, the U-turn output signal being operable to actuate the first U-turn signal indicator on said front end of the vehicle and the second U-turn signal indicator on said rear end of the vehicle.

2. The system of claim 1 wherein the first U-turn indicator and the second U-turn indicator are shaped to specify a path traversed when the vehicle makes a U-turn.

3. The system of claim 1 wherein the first U-turn indicator and the second U-turn indicator are shaped like an inverted U.

4. A system to indicate a direction of travel for a vehicle, the system comprising:
a U-turn signal actuator operable to indicate an intent to change a direction of travel of said vehicle from one direction to a substantially opposite direction;
a signaling system, the signaling system comprising one or more U-turn signal indicators, said one or more U-turn signal indicators displaying the intent to change the direction of travel of said vehicle from the one direction to a substantially opposite direction, the signaling system being actuated upon manipulation of the U-turn signal actuator; and
a control circuitry, the control circuitry further comprising a U-turn input signal, the U-turn input signal being triggered by manipulation of the U-turn signal actuator, the control circuitry further comprising a U-turn output signal, the U-turn output signal based at least in part on the U-turn input signal, the U-turn output signal being operable to actuate the signaling system to display the intent to change the direction of travel of the vehicle from the one direction to the substantially opposite direction.

5. The system of claim 4 wherein the signaling system forms a U shape that defines the vehicle path when reorienting into the substantially opposite direction.

6. The system of claim 4 wherein the signaling system comprises a U-shaped arrow.

7. The system of claim 4 wherein the signaling system is inverted U-shaped.

8. The system of claim 4 wherein a front end of the vehicle comprises two U-turn signal indicators and a back end comprises two U-turn signal indicators.

9. The system of claim 4 wherein one or more U-turn signal indicators are positioned on a rear roof of the vehicle.

10. The system of claim 4 wherein the signaling system flashes at a rate of between 60-120 times per minute.

11. A method operable by a U-turn signaling system including a U-turn signal actuator, a control circuitry, and one or more U-turn signal indicators to indicate a direction of travel for a vehicle, the method comprising:
receiving a user-actuated signal of an intent to change a direction of travel of the vehicle from one direction to a substantially opposite direction; and
displaying the intent to change the direction of travel of the vehicle from said one direction to said substantially opposite direction, wherein the intent is displayed by generating a U-turn input signal based on the user-actuated signal of intent to change the direction of travel from one direction to the substantially opposite direction, and generating a U-turn output signal, the U-turn output signal based at least in part on the U-turn input signal, to display the intent to change the direction of travel of the vehicle from one direction to the substantially opposite direction.

12. The method of claim 11 wherein the intent to change the direction of travel is displayed via said one or more U-turn signal indicators.

13. The method of claim 12 wherein one or more U-turn signal indicators form a U shape to define the vehicle path when reorienting into the substantially opposite direction.

14. The method of claim 12 wherein one or more U-turn signal indicators flash at a rate of between 60-120 times per minute.
